(19) United States
(12) Patent Application Publication
(10) Pub. No.: US 2005/0183475 A1
(43) Pub. Date: Aug. 25, 2005

(54) Cable lock

(76) Inventor: Mo Liu, Tou-Liu City (TW)

Correspondence Address: LIU MO, P.O. Box 90, Tainan City, 704, TW

(21) Appl. No.: 10/785,164

(22) Filed: Feb. 20, 2004

(51) Int. Cl. E05B 67/06

(52) U.S. Cl. 70/49; 70/53

(57) ABSTRACT

A cable lock includes a body, a cable, a tubular cover fitting around the cable and consisting of plural metal rings continually connected with one another, a fix bolt attached with one end of the cable, and a removable bolt attached with the other end of the cable. The fix bolt is fixed with the body, and the removable bolt can be inserted in or pulled out of the body. The plural metal rings respectively have a round projection on one end, and a curved recess formed in the other end, allowing the metal rings may be connected with one another by engagement of the round projection of one ring with the curved recess of another ring so as to form the tubular cover so that the cable can bend together with the tubular cover, enhanced in its strength to obtain the anti-theft purpose of the cable lock.

### BACKGROUND OF THE INVENTION

1. Field of the Invention

This invention relates to a lock, particularly to one provided with a cable covered by a tubular cover consisting of a plurality of metal rings continually connected. The cable has its one end attached with a fix bolt to be firmly fixed with a lock body, and the other end attached with a removable bolt to be inserted in an insert hole in the lock body for locking something with the cable. The metal rings are connected with one another by means of a round projection formed in one end of each metal ring and a curved recess formed in the other end so that the round projection of one metal ring may engage with the curved recess of another metal ring to allow the cable protected by the tubular cover formed with the metal rings flexibly connected with one another. Thus the tubular cover can protect the cable from being easily cut off, having an anti-theft function.

2. Description of the Prior Art

A conventional cable lock shown in FIG. 1, includes a body 10 made of laminated metal sheets fixed together with rivets, a fix foot 11 with a hole 12 fixed on an upper side of the body 10, an insert hole 13 also on the upper side of the body 10, and a cable 14 covered with a soft protective tube 15. One end of the cable 14 is inserted in the hole 12 of the fix foot 11 and then the fix foot 11 is pressed sidewise to sandwich the end of the cable 14, and the other end of the cable 14 is inserted in a hole 17 of a removable foot 16 and then the removable foot 16 is pressed sidewise to sandwich the other end of the cable 14 therein. The removable foot 16 has an annular groove 18 near the lower end, and the lower end can be inserted in or pulled off the insert hole 13 of the body 10 and then can be firmly locked by a deadbolt in the body 10, which is moved by a key (not shown) rotated for an angle so that the cable 14 is locked with the body 10. On the contrary, if the key is rotated reversely, the deadbolt is retracted to unlock the removable foot 17 to free the cable 14 so that the cable 14 can be unlocked from the body 10.

However, the conventional cable lock has the cable 14 protected by the soft tubular cover 15, and some of the steel wires of the cable 14 are liable to be damaged by frequently twisted as to break off. Then the broken-off wires may hurt the tubular cover 15 or the hands of a user, and the tubular cover 15 does not upgrade the strength of the cable 14, letting the cable 14 cut off by thieves, losing its anti-theft function.

### SUMMARY OF THE INVENTION

This invention has been devised to offer a cable lock, which has a cable increased in its strength by a tubular cover for upgrading anti-theft function of the cable lock.

The feature of the invention is a tubular cover fitting flexibly around the cable, and the tubular cover is made of plural metal rings connected with one another by means of a round projection formed on one end of each metal ring and a curve recess formed in the other end of each metal ring. Then the tubular cover has a flexibility to bend freely together with the cable. The cable has one end attached with a fix bolt, which is fixed in a fix hole of a lock body, and other end attached with a removable bolt, which is able to be inserted in or pulled out of an inserted hole of the lock body so as to lock or unlock the cable lock by using a key at the same time.

### BRIEF DESCRIPTION OF DRAWINGS

This invention will be better understood by referring to the accompanying drawings, wherein:

FIG. 1 is an exploded perspective view of a conventional cable lock;

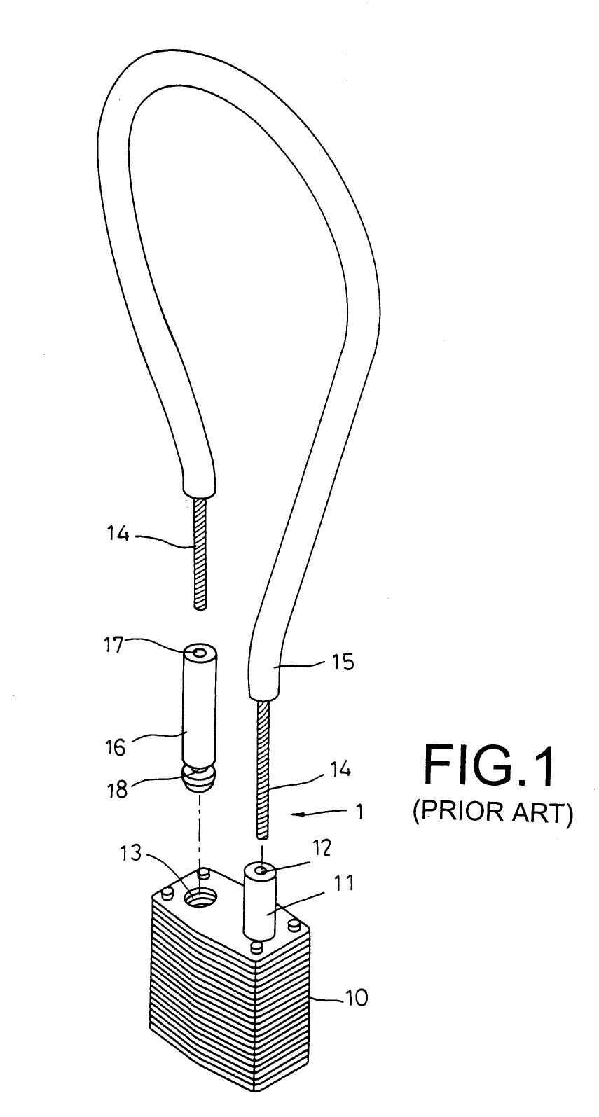

FIG. 2 is an exploded perspective view of a first embodiment of a cable lock in the present invention;

FIG. 3 is a cross-sectional view of a cable combined with rings connected continually in the present invention;

FIG. 4 is a perspective view of the cable lock under a locked condition in the present invention; and,

FIG. 5 is an exploded perspective view of a second embodiment of a cable lock in the present invention.

### DETAILED DESCRIPTION OF THE PREFERRED EMBODIMENT

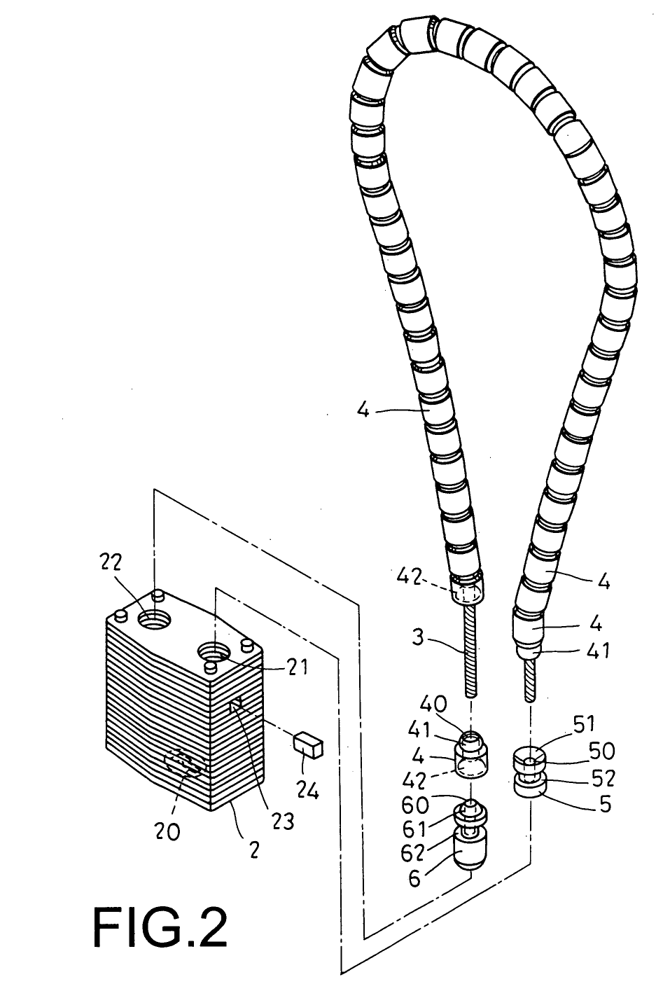

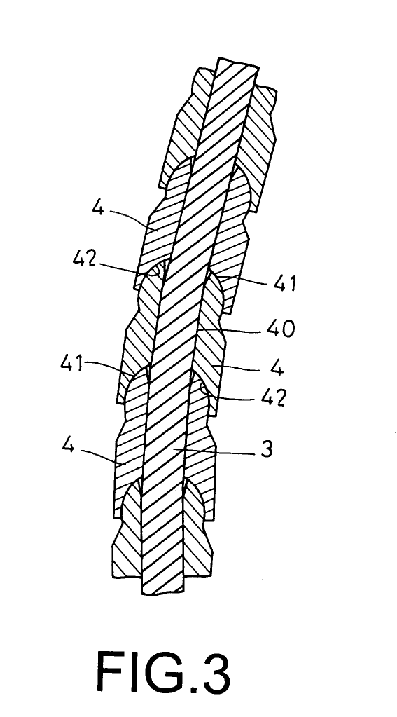

A first embodiment of a cable lock in the present invention, as shown in FIGS. 2 and 3, includes a body 2 made of laminated metal sheets fixed together with rivets, a cable 3, a tubular cover made up of plural metal rings 4, a fix bolt 5, and a removable bolt 6 as main components.

The body 2 has a key hole 20 in a lower side, a fix hole 21 and a insert hole 22 spaced apart in an upper side, and a pin hole 23 in a vertical side communicating with the fix hole 21 for a fix pin 24 to fit firmly therein.

The cable 3 is to be combined with the body 2, having good flexibility to freely bend, and the tubular cover fits around and protects the cable 3, made up with plural metal rings 4 continually connected with one another Each ring 4 has one end formed with a round projection 41 and the other end formed with a curved recess 42, so the round projection 41 of one ring 4 can engage with the curved recess 42 of another ring 4 located next to each other so as to make up the tubular cover. Thus the tubular cover is flexible to bend freely together with the cable 3.

The fix bolt 5 is attached with one end of the cable 3, and then fixed firmly in the insert hole 21, having a hole 50 for one end of the cable 3 to fit firmly therein, and one end formed with a curved recess 51 for receiving the round projection 41 of the ring 4 and an annular groove 52 near the lower end.

The removable bolt 6 is attached with the other end of the cable 3, and inserted in or pulled out of the insert hole 22 of the body 2, having a hole 60 on an upper end for one end of the cable 3 to fit firmly therein, and a round projection 61 on a lower end for the curved recess 42 to fit with and an annular groove 62 near the upper end.

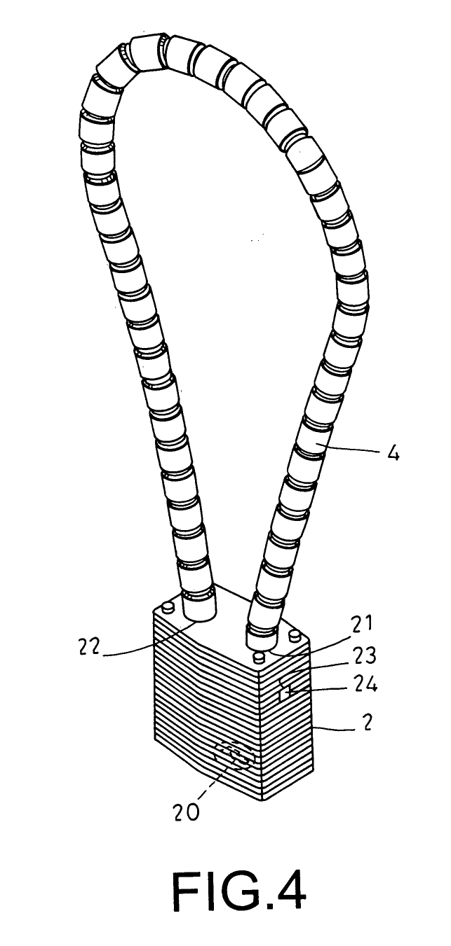

In assembling, firstly, the metal rings 4 are continually connected with one another around the cable 3, with the round projections 41 of one ring 4 engaging with the curved recess 42 of a neighboring ring 4, as shown in FIGS. 2, 3 and 4. Then insert one end of the cable 3 firmly in the hole 50 of the fix bolt 5, and subsequently press sidewise the fix bolt 5 to sandwich tightly the end of the cable 3 therein. Next, insert the other end of the cable 3 in the hole 60 of the removable bolt 6, and press sidewise the removable bolt 6 to sandwich tightly the other end of the cable 3 therein. Thus, the tubular cover and the fix bolt 5 and the removable bolt 6 are secured with the cable 3. Then the fix bolt 5 is inserted in the fix hole 21 and insert the fix pin 24 in the lock hole 23, with the inner end of the fix pin 24 fitting in the annular groove 52 of the fix bolt 5 so that the fix bolt 5 may be secured in the body 2. Thus the cable lock is finished in its assembly.

Next, how to lock or unlock the cable lock is to be described. Firstly, the key is inserted in the key hole of the body 2, and rotated for a certain degrees for rotating the lock core (not shown in the Figures), which then shifts the deadbolt to move in the annular groove 62 of the removable bolt 6 and the annular groove 52 of the fix bolt 5, locking the cable lock. Thus, the tubular cover can be bent together with the cable 3, reinforcing the cable 3 to prevent largely the cable from being cut off illegally by a thief. Should small wires of the cable 3 break off, the tubular cover formed with the metal rings 4 completely covering around the cable 3 can keep the broken-off small wires from exposed out, quite safe in using the cable lock.

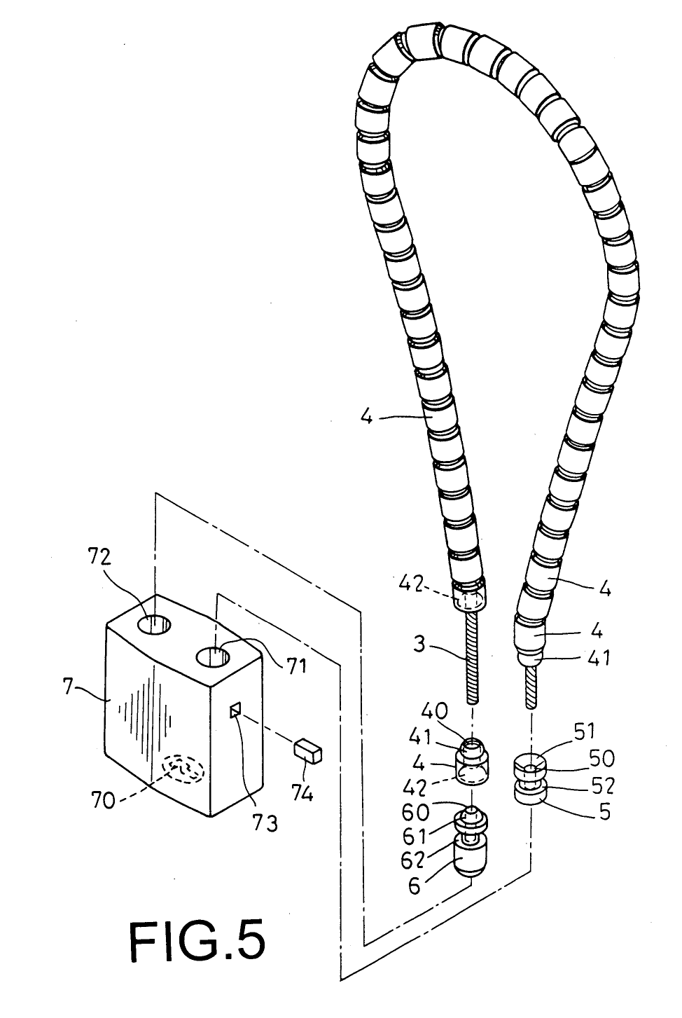

Next, FIG. 5 shows a second embodiment of a cable lock in the invention, which has the same structure as the first embodiment except that the body 7 is made solid, not made of laminated metal sheets. The other features are the same as the first embodiment, with a key hole 70 in the lower side, a fix hole 71 and an insert hole 72 in the upper side of the body 7, the a pin hole 73 in a vertical side of the body 7 communicating with the fix hole 71 for a fix pin 74 to fit therein. Then the fix bolt 5 and the removable bolt 6 are combined with the body 7 in the same way as the first embodiment to let the cable lock of the second embodiment have the same function as the first one.

While the preferred embodiments of the invention have been described above, it will be recognized and understood that various modifications may be made therein and the appended claims are intended to cover all such modifications that may fall within the spirit and scope of the invention.

1-2. (canceled)

3. A cable lock comprising:
a body having a key hole in a lower side, a fix hole and an insert hole spaced apart in an upper side, and a pin hole in a vertical side communicating with the fix hole for a fix pin to fit firmly therein; the fix hole and the insert hole are at the side of the body;
a cable combined with the body, having good flexibility to freely bend, and a tubular cover fits around and protects the cable, made up with plural metal rings continually connected with one another; each ring having one end formed with a round projection and the other end formed with a curved recess, so the round projection of one ring is engaged with the curved recess of another ring located next to each other so as to make up the tubular cover; thus the tubular cover is flexible to bend freely together with the cable;
a fix bolt attached with one end of the cable, and then fixed firmly in the insert hole, having a hole for receiving the cable to fit firmly therein, and one end of the fixing bolt being formed with a curved recess for receiving the round projection of the ring and an outer middle section of the fix bolt being formed with an annular groove which has a flat annular bottom;
a removable bolt attached with the other end of the cable, and inserted in or pulled out of the insert hole of the body, having a hole on an upper end for receiving one end of the cable to fit firmly therein, and a round projection for receiving a lower end of the curved recess and an outer middle section of the removable bolt further having an annular groove which has a flat annular bottom and two sides of annular groove have an equal diameter;
wherein in assembling, the metal rings are continually connected with one another around the cable, with the round projections of one ring engaging with the curved recess of a neighboring ring; then insert one end of the cable firmly in the hole of the fix bolt, and subsequently press sidewise the fix bolt to sandwich tightly the end of the cable therein; next, insert the other end of the cable in the hole of the removable bolt, and press sidewise the removable bolt to sandwich tightly the other end of the cable therein; thus, the tubular cover and the fix bolt and the removable bolt are secured with the cable; then the fix bolt is inserted in the fix hole and insert the fix pin in the lock hole, with the inner end of the fix pin fitting in the annular groove of the fix bolt so that the fix bolt may be secured in the body; thus the cable lock is finished in its assembly.
